(19) United States
(12) Patent Application Publication
(10) Pub. No.: US 2008/0312765 A1
(43) Pub. Date: Dec. 18, 2008

(54) Design and Production of Garments

(75) Inventors: James Holden Patrick Gardiner, Near Kilmarnock (GB); Timothy Bryan Niblett, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: VIRTUAL-MIRRORS LIMITED, Edinburgh (GB)

(21) Appl. No.: 12/279,669

(22) PCT Filed: Feb. 15, 2007
(86) PCT No.: PCT/GB07/00529

§ 371 Date: Aug. 15, 2008

(30) Foreign Application Priority Data
Feb. 16, 2006 (GB) 0603106.6

(51) Int. Cl. G06F 19/00; G06F 17/50

(52) U.S. Cl. 700/132

(57) ABSTRACT

A customer body scan is used to produce a body model. The body model is matched to the best fitting one of a family of standard body models. In one arrangement, that family is a series of standard size models. In another arrangement, the family is a series of body shapes. In both cases, difference values are derived which are used to modify standard pattern pieces. Closed manifold mesh models may be used throughout to simplify computation.

### CROSS-REFERENCE TO RELATED APPLICATIONS

This application claims the priority to the benefit of International Patent Application PCT/GB2007/000529 with an International Filing Date on Feb. 15, 2007, with subsequent publication as International Publication Number WO 2007/093800 on Aug. 23, 2007. PCT/GB2007/00529, in turn, claims priority to Great Britain Patent Application No. 0603106.6, filed Feb. 16, 2006. The disclosures of each of the aforementioned patent documents are incorporated herein by reference in its entirety.

### BACKGROUND

This invention relates to the design and production of garments.

The designing of garments is largely an art based on individual skills and experience. In mass produced garments, it is customary to make a prototype garment for a standard-sized body, adjusting the garment by hand until a satisfactory fit is achieved. Pattern pieces for the standard size are then created. Pattern pieces for other sizes are made by “grading” the pattern pieces for the basic standard size. The end result is a garment available in a range of sizes, which will be a less than perfect fit on most customers. One skill of the designer lies in achieving a garment which is a reasonable fit for a reasonably high proportion of potential customers, but this is a difficult aim to achieve.

Over the last twenty years or so a range of computer-aided design techniques has been available to the garment designer. For example, software packages are available to assist in the grading process and to deal with factors such as seam allowances. However, these are essentially aids to carrying out parts of the traditional design process.

It is of course also possible to produce bespoke garments which are tailored individually for a specific customer. The tailor takes a series of measurements which, combined with skilful judgment about the body shape and posture of the customer, are used to produce a rough version of the garment, which is then improved by a series of “fittings” and adjustment. This process is time consuming and requires a high level of skill which makes it expensive.

Our International Patent Application WO2002/057964 describes methods and systems for the production and visualization of garments. The present application is separate and independent from this prior application, but certain parts of the disclosure of WO2002/057964 can optionally be used in conjunction with the present invention.

There have been other previous proposals to provide automated systems for generating custom garments based on 3D body scanning. However, these have been based upon extracting measurements from the body scan, and this has proved not to be sufficiently accurate to produce well-fitting garments.

It is known to make semi-bespoke garments by a process which may be termed a “try-on” process. In this, the customer tries on a garment selected from a range of sizes as being the best available fit. A shop assistant checks a number of fit areas, such as arm length, hem length, shoulder width, back length, etc., and determines appropriate corrections to the closest fitting (termed base) garment. These corrections are then fed into CAD software which alters the pattern pieces for the closest fitting garment to produce a correctly altered garment.

The try-on method is superior to the construction of a custom garment from measurements alone for two reasons. First, measurements are of limited accuracy and precision in real-world tailoring, which makes alterations based on these measurements unreliable. Second, the alterations needed to the base garment can be difficult to determine with simple measurements, requiring knowledge of more sophisticated descriptions of body shape and posture. It is difficult, for example, to describe stooped shoulders in terms of measurements.

Experience has shown that a try-on process can reliably provide good fit if performed by skilled assistants. However, it has the problems in terms of mass customization that:
A stock of garments is required in order to operate the try-on, which makes changing designs expensive as a complete set of graded garments is required in each outlet.
A degree of tailoring skill is required on the part of shop assistants to be able to specify the necessary changes.
It is difficult to change designs, as it is expensive and time-consuming to train assistants on new sets of alterations.

These problems make it difficult to provide more than a limited range of styles, changes to the range happen only infrequently, and volume is limited by the number of trained assistants and the time taken to deal with individual customers.

### SUMMARY

Accordingly, one object of the present invention is to provide a method and system for producing a good fit in garments customized to individual customers, in a manner which requires no or minimal human intervention in the customization process, and which eases the task of the garment designer at the initial stages.

Another object of the present invention is to provide benefits analogous to the “try-on” system in a system suitable for mass customization while avoiding the limitations of the try-on system referred to above.

### BRIEF DESCRIPTION OF THE DRAWINGS

The invention provides a method of producing garments, and a garment production system, as defined in the appended claims. Embodiments of the invention will now be described, by way of example, with reference to the drawings, in which:

FIG. 1 is a flowchart of a first stage in one process embodying the invention; and

FIG. 2 is a flowchart of a subsequent stage in the same process.

### DETAILED DESCRIPTION OF THE EMBODIMENTS

The benefits of the known try-on system arise from the fact that small changes are made to a known fit, namely the fit of the selected base garment on the customer. The present invention builds upon making changes to a known solution, but using body models rather than measurements.

### First Embodiment

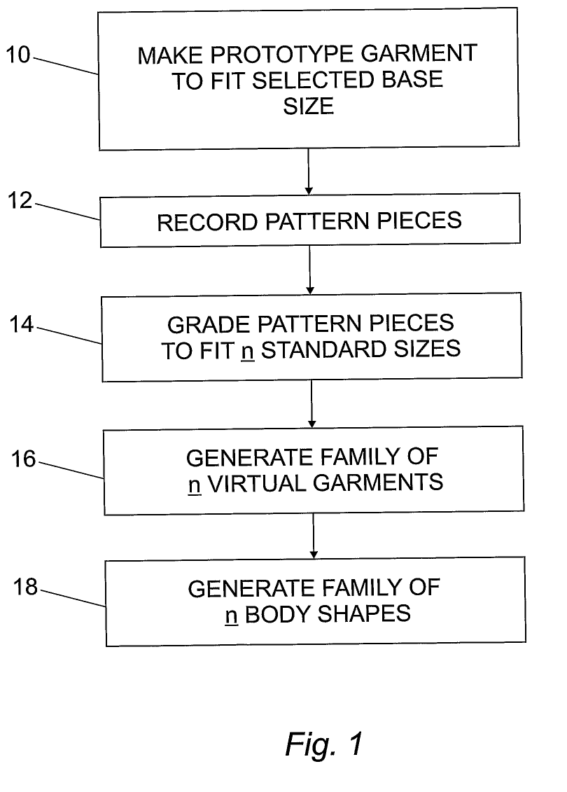

Referring to FIG. 1, in one embodiment of the invention a first step 10 is to make a base garment to fit a selected base size, say a standard size 12. This is done by any conventional method, the designer adjusting the garment until a desired style and fit is achieved. The pattern pieces which achieve this are then recorded at step 12, along with related information such as seam allowances and seam matching points. Software (for example, Accumark from Gerber Technology or PGS from Lectra Systems) is commercially available for recording such information in a form which can be digitally manipulated.

In the following step 14, the pattern pieces for the base garment are graded (adjusted) to give pattern pieces for additional standard sizes, say for sizes 6-10 and 14-24. This can be effected using known commercially available grading software, or by using the method of WO2002/057964 to produce virtual graded garments. Alternatively, or in addition, preliminary grading results can be used to make prototype garments for each of the other desired sizes, which are then adjusted for best fit. The result of step 14 is a family of pattern pieces for each of a range of n standard sizes. This allows, at step 16, the creation of a database of a family of n virtual garments.

In the present invention, body models are used rather than measurements. A body model is a complete 3D representation of a human body, generated from the data supplied by a body scanner. A common form of body model, suitable for use in the present invention, is a closed 2-manifold triangle mesh derived from a single template mesh, so that vertices and triangles are in 1-to-1 correspondence between different body models. The derivation of such a body model from body scanner data is well known in the art.

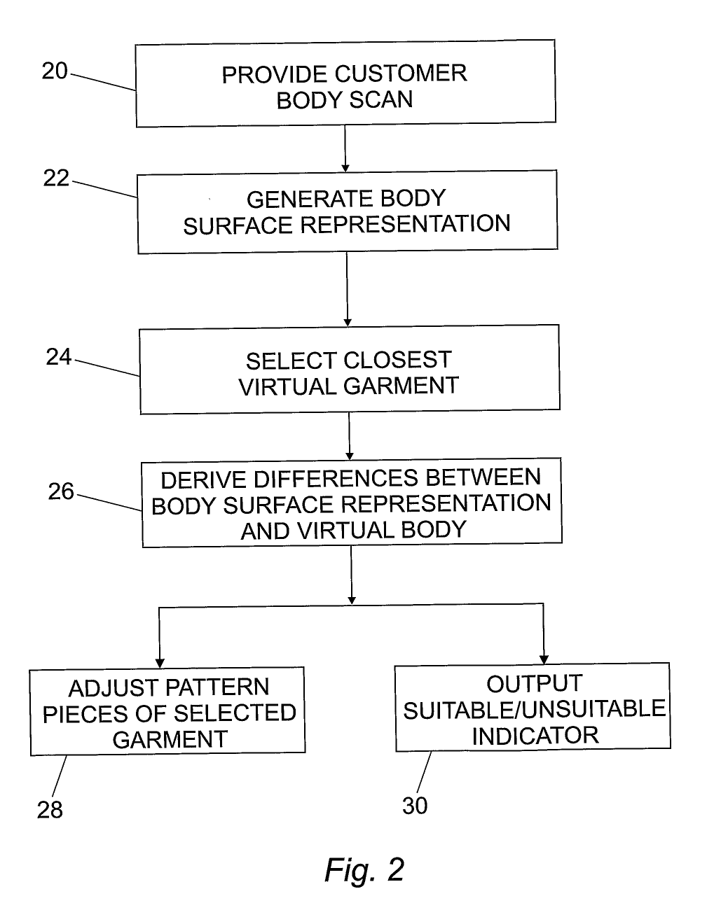

Referring to FIG. 2, there is depicted the process for producing a garment customized for a given customer in the particular style created in FIG. 1.

At step 20, a body scan of the customer is provided. This may be done by taking a scan in a body scanner, or by re-using a body model from a previous body scan of that customer. The body scan data is then used at 22 to generate a body model or surface representation, preferably in the form of a closed 2-manifold triangle mesh as discussed above.

The next step 24 is to identify the one of the family of virtual garments which is the best fit to the customer's body model. One way to do this is to recognize the customer body as being closest to a size 12, 14, etc.

The differences between a body model representing a reference body fitting that garment size and the scanned customer body are then established at 26. Suitably, the reference body is represented as a similar triangle mesh to the customer body, and the differences are established by a process of Ordinary Procrustes Analysis [Dryden and Mardial 1997; Goodall 1991] at selected vertices.

As a modification, the closest reference body can be established by comparing the customer body directly with a series of body models representing idealized bodies on which the sized garments are a perfect fit.

The differences derived can be used in two ways. One (step 30) is simply to give an output indicating whether that garment style can or cannot be made in a form suitable for that customer. Another way to consider this is to view the process as an assessment of the suitability of the style for the body shape under consideration. The other (step 28) is to use the derived differences to adjust the pattern pieces for the garment, the adjusted pattern pieces then being used to manufacture an actual garment for the customer.

In one preferred form, the differences are analyzed between the customer body and an idealized body for the closest standard size and a series of difference parameters are computed. One typical parameter might be shoulder angle. For each of the difference parameters a garment alteration is performed on the pattern pieces for the selected sized garment. The final output is a modified garment which fits the customer. This is similar to the tailoring alterations performed in a conventional try-on method, but the alterations are derived from differences in body shape rather than from manual measurements. The use of parameters derived from the differences between two similar body shapes is a significantly more robust method than the use of linear measurements.

The garment alterations are a specification of how the pattern pieces change with the value of a given parameter. It is assumed that alterations are linear with parameter value, so that an alteration can be computed for each parameter value within a specified range. It is further assumed that the alterations are composable, so that they can be applied independently; this assumption generally holds good if the alterations are small.

It will be appreciated once the pattern has been adjusted the garment may be manufactured by printing out physical adjusted pattern pieces for manual garment cutting, but more usually virtual pattern pieces will be adjusted and then translated into output data for a computer-controlled cutting machine.

### Further Embodiments

The above embodiment relies on the use of a range of sizes designed for a set of standard bodies. Either traditional garment sizes or, in effect, garment sizes with infinitesimally small increments between them may be used. In a further refinement of the invention, the customer's body model is compared with a range of body shapes each of which can be scaled for size.

An eigen-model is a generalization of a body sizing system, being continuous rather than discrete. The eigen-model consists of a parameterized family B of body models. Each body model bεB is a closed 2-manifold triangle mesh with a fixed topology. The only difference between different elements of B is in the location of vertices. This allows for comparison between different body models in B on a point wise basis.

If the vertices in bεB are v₀, . . . , vₘ, the vertices can be written as a 3×m vector (x₀, x₁, x₂, . . . , xₙ) where n=3m and vᵢ=(x₃ᵢ, x₃ᵢ₊₁, x₃ᵢ₊₂). Such a vector completely characterizes b. Such vectors may be referred to as x, y, z, etc.

The eigen-model contains an average body model b₀ with vector x₀. The model contains a non-empty set of parameters Pᵢ,0≦i≦n. With each parameter Pᵢ is associated a vector yᵢ. The vectors yᵢ are orthogonal so that yᵢ·yⱼ,=0, i≠j (where · is the dot product operator). Given a set of values pᵢ for the Pᵢ a body model b exists with vector x₀+Σᵢpᵢyᵢ.

Matching a Body Model

To match a body model b the following process is followed.

1. b is matched to b₀ vertex-wise using Ordinary Procrustes Analysis (OPA) [Dryden and Mardia, 1977, Goodall, 1991]. The vector of the transformed b is z.

2. For each parameter Pᵢ the value pᵢ is computed as (z−x₀)·yᵢ. The resultant body model is bₛ.

3. A scale parameter s is computed by performing OPA from bₛ to b. The scale is necessary because the average body model is scale-free, and a shape is represented in the eigen-model. Body model bₛ is then scaled by s to find the closest approximation to b in the eigen-model.

By construction, since the parameter vectors are orthogonal, the match found in this way is the closest match in the least squares sense.

Matching a Garment to a Body Model

The try-on approach essentially enables an association between a garment g and each eigen-model b, where g is known to be a good fit to b. The association takes place as follows:
A garment g₀ is associated with b₀, the average body;
Each parameter pᵢ has a garment delta dᵢ;
A garment for a body shape b given by the vector z₀+Σᵢpᵢyᵢ is given by g=g₀+Σᵢpᵢdᵢ.

It is important that computation of the garment associated with a body model be straightforward. The preferred embodiment is to use linear interpolation to generate garments, both in 3-D, draped on the body, and as 2-D pattern pieces.

Linear interpolation requires two bodies, b₀ and b₁ and two garments g₀ and g₁ which fit these bodies. Body b₀ is the average body with vector x₀ and b₁ is a body with vector x₀+λyᵢ, namely a body that differs from the average body by a multiple of the i^{th} eigenvector. Linear interpolation requires that the operations of addition and multiplication by a scalar are defined on bodies and garments. Since bodies are defined by the location of their vertices in space, where the vertices are 3-D points, these operations are inherited from those on points. In our preferred embodiment both 2-D pattern pieces and 3-D draped garments are represented by triangle meshes and can be interpolated by interpolation of individual vertices.

Given bodies b₀, b₁ and garments g₀, g₁ as above the garment delta is dᵢ=(g₁−g₀)/λ. In order for the interpolated garment to be “correct” it is important that:

1. the meshes to be interpolated be aligned, and that

2. the 3-D drape of g₀ and g₁ are consistent.

These conditions ensure that the angles between matching edges in g₀ and g₁ are as small as possible. When the angles are significantly different the accuracy of the interpolation decreases.

It is possible to create the draped garments g₀ and g₁ in a variety of ways. In the preferred embodiment the base garment g₀ is created by sewing a physical garment which is fitted to a physical embodiment of body b₀. The garment g₁ can be created in the same way, by the process of grading which is well understood in the clothing industry, or by using the techniques of our International patent application WO2002/057964.

The process of garment matching as described is related to garment grading as commonly practiced. The differences in the present approach are:

1. Each garment has an associated body model which, by construction, the garment fits well. This is the key requirement of the try-on approach.

2. The garment is known both in its 2-D pattern pieces and also its 3-D shape.

3. An infinite number of different garments can be produced rather than a fixed set of sizes.

Creating Body Models

One method of creating a body model for the foregoing will now be described.

Body models can be created using Generalized Procrustes Analysis (GPA) [Gower, 1975, Dryden and Mardia, 1997] algorithm. The input is a set of body models. The average model is b₀ and the principal components of the cross-correlation matrix of differences to average (after OPA) are the parameter vectors.

The simplest way to create eigen models is to use a database of body shapes representative of the population which will wear the garment. If the eigen model is derived from a representative population, the average distance between the average body model b₀ and a customer body b is minimized.

The efficiency of the system is improved if only those vertices directly relevant to the garment concerned are used, both for the creation of the body models and for matching. For example, if a pair of trousers is considered the configuration of the upper body and arms is not a significant factor in the fit. The above description holds good without change when subsets of vertices are used.

Many clothing designers have a considerable investment in particular dummies, forms or fit models. Expertise is developed over years as to how best to design garments to fit these models. In these circumstances it makes sense for these body shapes to be members of B. The drawback is that the resultant eigen-model will not, in general, be as close to the population average.

Discussion

The method of the invention does not require any information for a customer other than a body scan. There is no requirement for try-on garments or for an expert assistant to compute garment alterations.

The effectiveness of the method depends on the closeness of the closest match and the customer body models. This calculation is robust, especially when via eigen-models and the differences which are produced are generally small. Initially, a garment is used whose fit on the closest matching stored body is perfect; this corresponds to the best fitting sized garment, within a range of sizes which may be step-wise or may be infinite. The differences, and hence the alterations required to that garment, are small and can be reliably computed.

The adjustments to be made are derived from a whole body model rather than a very limited number of measurements, giving a much more detailed comparison.

The invention also makes it possible to make use of the skills and expertise of industry professionals in developing prototype garments in a manner to which they are accustomed.

### REFERENCES

[Dryden and Mardia, 1997] I. L Marden and K. V. Mardia, Statistical Shape Analysis, Wiley, Chichester, 1997.
[Goodall, 1991] CR. Goodall, Procrustes methods in the statistical analysis of shape (with discussion). J. Roy. Statist. Soc. Ser. B, 53:285-339, 1991.
[Gower, 1975] J. C. Gower, Generalized procrustes analysis. Psychometrika, 40:33-51, 1975.

What is claimed is:

1. A method of producing a garment comprising:
establishing a base garment design which comprises a plurality of pattern pieces and is a desired fit on a given body model;
providing a body model of a customer using a body scanner;
automatically comparing the body model of the customer with the given body model to derive difference values;
modifying the pattern pieces using the difference values;
manufacturing a garment using the modified pattern pieces.

2. The method of claim 1 wherein establishing a base garment design comprises establishing a base garment design in a number of standard sizes each being a desired fit on a given body of a standard size.

3. The method of claim 1 wherein establishing a base garment design comprises establishing base garment designs for a family of dimensionless body models of differing shapes.

4. The method of claim 1 wherein the customer body model and the given body are each defined by a closed 2-manifold triangle mesh derived from a single template mesh.

5. The method of claim 1 wherein establishing the base garment design comprises:
physically making and adjusting one or more prototype garments; and
using the plurality of pattern pieces by digitizing the pattern pieces for each prototype garment.

6. The method of claim 1 wherein automatically comparing the body model of the customer with the given body model to derive difference values comprises comparing only body parts of the customer and the body model which are relevant for a particular garment.

7. (canceled)

8. A method of making a garment comprising:
comparing a representation of a customer body with a family of body models;
determining the best fit body model from the family of body models;
automatically identifying shape differences between the customer body and the best fit body model;
modifying pattern pieces which define a garment having a desired fit to the best fit body model using the shape differences; and
manufacturing the garment using the modified pattern pieces.

9. A garment production system comprising:
means for comparing a representation of a customer body with a range of body models and identifying a body model with a closest fit;
means for determining shape differences between the customer body and the closest fit body model;
means for using the differences to modify garment pattern pieces of a garment which fits the closest fit body model; and
a manufacturing module for manufacturing the garment using the modified pattern pieces.

10. The method of claim 1 wherein comparing the body model of the customer with the given body model to derive difference values comprises comparing the customer body model with a body model from a family of dimensionless body models which is most similar to the customer body model to derive the difference values.

11. The method of claim 1 wherein modifying the pattern pieces using the difference values comprises:
scaling the difference values to a customer size; and
adjusting the pattern pieces based on the scaled difference values.

12. The method of claim 8 wherein modifying pattern pieces comprises:
scaling the shape differences to a customer size; and
adjusting the pattern pieces based on the scaled difference values.

13. The method of claim 8 further comprising:
establishing a base garment design which comprises a desired fit on a best fit body model.

14. The method of claim 8 wherein automatically identifying shape differences between the customer body and the best fit body model comprises identifying shape differences in the customer body and the best fit body model which are relevant for a particular garment.

15. The method of claim 8, wherein the customer body model is defined by a closed 2-manifold triangle mesh derived from a single template mesh.

16. The method of claim 8, further comprising:
using the modified pattern pieces to cut and make a garment for the customer.
